(19) United States
(12) Patent Application Publication
(10) Pub. No.: US 2007/0240816 A1
(43) Pub. Date: Oct. 18, 2007

(54) PROTECTIVE GIRTH-WELD COVER WITH AIR RELEASE

(75) Inventors: Mark K. Nestegard, Mendota Heights, MN (US); Mark T. Anderson, Woodbury, MN (US); Dawn V. Muyres, Austin, TX (US); Mario A. Perez, Burnsville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/698,000

(22) Filed: Apr. 9, 2007

Related U.S. Application Data
(60) Provisional application No. 60/744,966, filed on Apr. 17, 2006.

(51) Int. Cl. B32B 37/00

(52) U.S. Cl. 156/304.1; 156/84; 285/417

(57) ABSTRACT

A pipe system comprises first and second pipes having first and second ends welded together forming a girth-weld and a heat recoverable polymer material comprising a plurality of holes extending therethrough covering the girth-weld. The heat recoverable polymer material can include a surface having an adhesive coated thereon disposed on the girth-weld. Air trapped underneath the recoverable polymer material can be released through the plurality of holes during shrinking of the heat recoverable polymer material. Also, a portion of the adhesive can flow through the holes during a shrinking of the heat recoverable polymer material.

### CROSS REFERENCE TO RELATED APPLICATION

This application claims the benefit of U.S. Provisional Patent Application No. 60/744,966, filed Apr. 17, 2006, the disclosure of which is incorporated by reference herein in its entirety.

### FIELD OF THE INVENTION

The present invention relates to a protective girth-weld cover system and method. More specifically, the present invention relates to a protective girth-weld cover system that provides for the release of air trapped under the girth-weld cover.

### BACKGROUND

In the oil and gas industry, transmission pipelines are laid to transport a variety of liquids and gases. These pipelines are formed of many miles of steel piping that can vary from 8 to 80 inches in diameter. Depending on the location and environmental conditions, the pipe may be installed above ground or buried. The exterior of the pipe can be in contact with highly corrosive environments, such as seawater, soil, rock, air, or other gases, liquids or solids.

To protect the pipes from stresses due to exposure from often extreme environmental conditions, the pipe exteriors are generally coated with a protective coating in the factory, not the site where the pipes are to be installed. Conventional protective coatings are described in J. A. Kehr, “Fusion-Bonded Epoxy (FBE): A Foundation for Pipeline Corrosion Protection”, NACE Press (Houston, Tex.), 2003 (see e.g., Chapter 4 and pages 234-246). For example, a three layer protective coating, that includes a fusion bonded epoxy, an adhesive, and a polyolefin topcoat, is typically applied to pipe in the factory.

However, the pipe ends are not coated, with about 6 inches (axial length) of uncoated pipe at each end, where pipe segments are welded together. The resulting welds are referred to as “girth-welds” or “field joints” and are not coated with a protective coating before the installation is complete.

As such, girth-welds can be susceptible to corrosion and other environmental effects. Several methods to protect the girth-weld are known. The most frequently used and accepted method is utilizing a protective cover, such as a heat shrink sleeve, to cover the girth-weld. However, conventionally installed heat shrink sleeves tend to provide diminished protection prior to the end of the expected service lifetime as the sleeves are susceptible to moving away from the weld, thereby leaving the joint unprotected. Moreover, most conventional installation processes leave heat shrink sleeves with bubbles and wrinkles, thus entrapping air underneath the protective cover. In addition, the use of a torch to shrink the protective sleeve is highly skill dependent, meaning that a completely and uniformly shrunk protective cover is not ensured under all circumstances.

Other approaches (and their problems) are described in J. A. Kehr, “Fusion-Bonded Epoxy (FBE): A Foundation for Pipeline Corrosion Protection”, NACE Press (Houston, Tex.), 2003 (see e.g., Chapter 7).

### SUMMARY

In one aspect, the present invention provides a heat recoverable polymer material comprising a plurality of holes extending therethrough. The heat recoverable polymer material can be part of a pipe system that includes first and second pipes having first and second ends welded together forming a girth-weld, where the heat recoverable polymer material comprising a plurality of holes extending therethrough is disposed to cover the girth-weld. The heat recoverable polymer material can be formed as a cover or sheet having a surface having an adhesive coated thereon.

In another aspect, a method of forming a protected girth-weld, comprises disposing a heat recoverable polymer material comprising a plurality of holes extending therethrough covering the girth-weld, and shrinking the heat recoverable polymer material over the girth-weld. The recoverable polymer material can include a surface having an adhesive coated thereon disposed on the girth-weld, where a portion of the adhesive flows through the holes during the shrinking step. The method can also include providing first and second pipes having first and second ends, welding the first and second pipe ends together to form the girth-weld, cleaning the girth-weld, coating the girth-weld with a corrosion coating, and curing the corrosion coating prior to the disposing step.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIGS. 1A-1C are schematic views of a girth-weld and of a heat recoverable protective coating having a plurality of holes according to an aspect of the present invention.

FIG. 2 shows a cross-section view of a pipe having a heat recoverable protective coating having a plurality of holes according to an aspect of the present invention.

These figures are not drawn to scale and are intended only for illustrative purposes. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

Aspects of the present invention relate to a protective cover for girth-welds having an air release mechanism. In an exemplary embodiment, a heat recoverable polymer material (such as a heat shrink sleeve or sheet) having a plurality or matrix of holes is provided to be placed over a girth-weld that can facilitate air release during the shrinking process. The porous structures (e.g., holes extending through the inner and outer surfaces of the heat recoverable polymer sheet) will automatically direct air out of the sleeve as the heat shrink sleeve is activated (e.g., by shrinking). This process can prevent entrapped air from remaining trapped underneath the protective cover. In a preferred aspect, as the sheet or sleeve is shrunk, an adhesive material (e.g., a hot melt adhesive or a mastic) can flow through the porous structures after all the air is removed from the system. With the adhesive material now filling the plurality of holes, a protective layer is reestablished, thus preventing penetration of external elements (e.g., water). The adhesive flow can also act as an indicator of correct installation. For example, the adhesive can be a color different from that of the sheet or sleeve. An indicator can thus be a contrasting color visible on a top surface of the sheet or sleeve (e.g., a pattern of different color dots would appear) when the installation is complete. Additionally, the porosity and contrasting protective media can reduce the cathodic shielding normally seen in a typical heat shrink sleeve, whereby the adhesive could be modified to be more conductive.

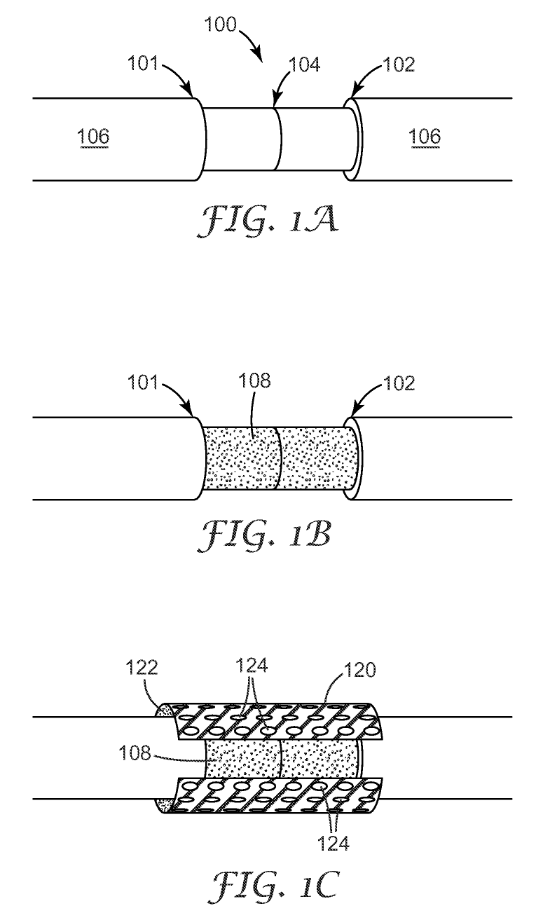

A first aspect of the present invention is shown in FIGS. 1A-1C, a pipeline 100 having a girth-weld 104 with a heat recoverable polymer material 120, such as a heat shrink protective cover, sheet, or sleeve. In this exemplary embodiment, girth-weld 104 joins pipe ends 101 and 102 and can be protected by exemplary heat recoverable polymer sheet 120. The heat recoverable polymer sheet 120 preferably surrounds the entire girth-weld.

Pipe ends 101, 102 can be formed from a standard pipe material, such as steel. Pipe ends 101, 102 also include an outer coating 106 that can comprise a conventional protective coating, such as a polyolefin-based coating. In an exemplary embodiment, protective coating 106 comprises a three-layer coating having an epoxy, an adhesive and a polyolefin top coat that are melt-fused together on the pipe ends 101, 102. As would be understood by one of ordinary skill in the art given the present description, other formulations of protective coatings, such as two-layer coatings, and those described in J. A. Kehr, “Fusion-Bonded Epoxy (FBE): A Foundation for Pipeline Corrosion Protection”, NACE Press (Houston, Tex.), 2003 (see e.g., Chapter 4 and pages 234-246) (incorporated by reference herein), can also be utilized as the protective coat 106.

As is also shown in FIG. 1A, in an exemplary embodiment, portions of the pipe coating 106, e.g., about 2 to 10 inches in length from the pipe ends, can be removed, stripped, or sanded off to help promote better welding in the field.

As shown in FIG. 1B, the girth-weld 104 can be coated with a corrosion (prevention) coating 108 after the welding operation. An exemplary corrosion coating 108 comprises an epoxy or urethane material. For example, the corrosion coating 108 can be a 2-part liquid system or a fusion bonded epoxy powder (e.g., prepared from a commercially available powdered SCOTCHCAST Resin 226N, available from 3M Company, St. Paul, Minn.).

As shown in FIG. 1C, the heat recoverable polymer material 120 includes a plurality of holes 124 extending through the material. The holes can be formed in a random manner or may be provided in an ordered pattern or matrix. For example, holes 124 can be from about 0.1 mm to about 10 mm in diameter, preferably from about 0.1 mm to about 1 mm in diameter. The density of holes 124 formed in heat recoverable polymer material 120 can cover from about 0.01% to about 25% of the total surface area of the heat recoverable polymer material 120, preferably from about 0.1% to about 2% of the total surface area of the heat recoverable polymer material 120. The holes 124 can be formed in heat recoverable polymer material 120 through a standard technique, such as mechanical process (e.g., drilling, puncturing, etc.), focused radiation (e.g., laser, or other), or thermal process. The size and density of holes 124 can be varied to provide for optimal air release without adversely affecting the structural integrity or performance of the heat recoverable polymer material 120.

The heat recoverable polymer material 120 can comprise a pre-expanded EPDM rubber or cross-linked polyethylene materials. Other example materials that can be used to form heat recoverable polymer material 120 includes those described in U.S. Pat. No. 6,015,600, and commercially available materials such as are available from Raychem (e.g., model WPCT M05106).

Further, an inner surface of the heat recoverable polymer material 120 can optionally be coated with an adhesive layer or coating 122 to help further bond the heat recoverable polymer material 120 to the pipe ends 101, 102. For example, the adhesive layer 122 can comprise a mastic or hot melt material. In one exemplary embodiment, the adhesive or coating 122 can have a color different from the color of the heat recoverable polymer sheet 120. Alternatively, adhesion of the heat recoverable polymer material 120 to the girth-weld region can be accomplished using corrosion coating 108.

In operation, a girth-weld is formed in the field by joining pipe ends 101 and 102. After welding, optionally, the girth-weld area can be further cleaned. Additionally, a field-applied corrosion coating 108 can be applied to the girth-weld. This optional coating 108 can be a liquid epoxy, such as Scotchcast 323 available from 3M Company, St. Paul, Minn.

After the optional corrosion coating 108 is applied and/or at least partially cured, heat recoverable polymer sheet 120 having a plurality of holes 124 is disposed (e.g., wrapped) over the girth-weld 104. As mentioned above, in an exemplary embodiment, an inner surface of the heat recoverable polymer sheet 120 is coated with an adhesive layer 122.

To conform the heat recoverable polymer material 120 to the surface of the girth-weld region, heat is applied (e.g., via a hot air gun or torch) to material 120. In one exemplary embodiment, the protective sleeve is wrapped around the pipe (to cover the girth-weld), then sealed longitudinally (e.g., by heating the overlap region). The sleeve can then be shrunk by applying heat. A technician, for example, can start at the center of the sleeve (with the weld seam being directly underneath the sleeve) and can seal the sleeve around the pipe by heating radially, working outward (longitudinally) from the middle, while alternating in each direction, to completely shrink the sleeve.

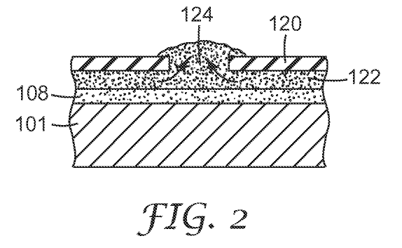

As the heat recoverable polymer material 120 is shrunk, air trapped underneath can be released through holes or pores 124 formed in sheet 120. As shown in FIG. 2, air trapped, for example between corrosion coating 108 and adhesive 122 can be forced out through hole 124 as the sheet 120 is shrunk via suitable heating. After the trapped air has escaped, a portion of adhesive 122 can then flow through hole 124.

This exemplary embodiment can reduce or eliminate undesirable bubbles and wrinkles that often form under protective covers, helping to ensure more optimal conformity to the weld. Further, the above method and system can reduce the likelihood of incomplete installation, as the bubbles formed during shrinking can be visually monitored in a straightforward manner. Moreover, different colors for the adhesive and heat recoverable polymer material 120 can be selected to provide greater visual contrast as bubbles form in the plurality of holes to indicate the completion of the process.

In another embodiment, the adhesive 122 can be modified to have some conductive properties, for example, by chemically modifying the adhesive with polar groups (e.g. maleated polyolefin) or by adding conductive nanoparticles to the adhesive. As the adhesive 122 is designed to penetrating the sleeve 120 through holes 124, this arrangement can provide for the current to flow to ground and reduce the shielding effect of the bulk sleeve.

While the present invention has been described with a reference to exemplary preferred embodiments, the invention may be embodied in other specific forms without departing from the scope of the invention. Accordingly, it should be understood that the embodiments described and illustrated herein are only exemplary and should not be considered as limiting the scope of the present invention. Other variations and modifications may be made in accordance with the scope of the present invention.

It is claimed:

1. A pipe system, comprising:
first and second pipes having first and second ends welded together forming a girth-weld; and
a heat recoverable polymer material comprising a plurality of holes extending therethrough covering the girth-weld.

2. The pipe system of claim 1, wherein the heat recoverable polymer material comprises a surface having an adhesive coated thereon.

3. The pipe system of claim 2, wherein the adhesive comprises one of a mastic material and a hot melt material.

4. The pipe system of claim 1, further comprising a corrosion coating covering the girth-weld.

5. The pipe system of claim 4, wherein the corrosion coating comprises a two-part epoxy.

6. The pipe system of claim 1, wherein the plurality of holes are arranged in a pattern.

7. The pipe system of claim 1, wherein the plurality of holes are from about 0.1 mm to about 10 mm in diameter, and wherein the plurality of holes cover from about 0.01% to about 25% of a surface area of the heat recoverable polymer material.

8. The pipe system of claim 1, wherein the plurality of holes are from about 0.1 mm to about 1 mm in diameter, and wherein the plurality of holes cover from about 0.1% to about 2% of a surface area of the heat recoverable polymer material.

9. A heat recoverable polymer material having first and second surfaces comprising a plurality of holes extending through the first and second surfaces.

10. The heat recoverable polymer material of claim 9, wherein the second surface has an adhesive coated thereon, the adhesive selected from a mastic material and a hot melt material.

11. The heat recoverable polymer material of claim 9, wherein the plurality of holes are arranged in a pattern, wherein the plurality of holes are from about 0.1 mm to about 10 mm in diameter, and wherein the plurality of holes cover from about 0.01% to about 25% of a surface area of the heat recoverable polymer material.

12. The heat recoverable polymer material of claim 11, wherein the plurality of holes are from about 0.1 mm to about 1 mm in diameter, and wherein the plurality of holes cover from about 0.1% to about 2% of a surface area of the heat recoverable polymer material.

13. A method of forming a protected girth-weld, comprising:
disposing a heat recoverable polymer material comprising a plurality of holes extending therethrough covering the girth-weld; and
shrinking the heat recoverable polymer material over the girth-weld.

14. The method of claim 13, wherein the recoverable polymer material comprises a surface having an adhesive coated thereon disposed on the girth-weld, and wherein a portion of said adhesive flows through the holes during the shrinking step.

15. The method of claim 13, further comprising:
providing first and second pipes having first and second ends;
welding the first and second pipe ends together to form the girth-weld;
cleaning the girth-weld;
coating the girth-weld with a corrosion coating; and
curing the corrosion coating prior to the disposing step.

16. The method of claim 13, wherein the adhesive comprises a different color than a color of the heat recoverable polymer material.

17. The method of claim 14, wherein the flow of adhesive through the plurality of holes indicates a release of entrapped air.
